(19) United States
(12) Patent Application Publication
(10) Pub. No.: US 2022/0268374 A1
(43) Pub. Date: Aug. 25, 2022

(54) HUMANIZED HEAVY HAMMER STRUCTURE

(71) Applicant: Xiamen EASO Co.,Ltd., Xiamen (CN)

(72) Inventors: Hai tao Lu, Xiamen (CN); Zhen Li, Xiamen (CN); Wei hai Xie, Xiamen (CN); Xi min Chen, Xiamen (CN)

(73) Assignee: Xiamen EASO Co.,Ltd., Xiamen (CN)

(21) Appl. No.: 17/496,059

(22) Filed: Oct. 7, 2021

(30) Foreign Application Priority Data
Feb. 22, 2021 (CN) 202120391289.X

(51) Int. Cl. F16L 3/18; F16L 3/10

(52) U.S. Cl. CPC F16L 3/18; F16L 3/1075

(57) ABSTRACT

The present invention discloses a humanized heavy hammer structure, comprising a plastic body, a configuration metal block and a fixed block, wherein the plastic body is provided with a swing arm, an accommodating part and a U-shaped accommodating space, the configuration metal block and the fixed block are sequentially arranged in the U-shaped accommodating space, the accommodating part is an-armed along; the outer periphery of the plastic body, the swing arm can swing around the plastic body, and when closed, the swing arm and the accommodating part are mutually buckled, the configuration metal block is completely covered between the plastic body and the fixed block, and the configuration metal block is provided with a U-shaped notch, the fixed block is arranged in the U-shaped notch and connected with the configuration metal block, and a hose is provided in the middle of the fixed block. The present invention through the structural design of the fixed block and the counterweight metal block can effectively solve the problem that the counterweight metal of the product produced during the injection molding process is exposed outside; and the whole heavy hammer structure can be more conveniently mounted and dismounted in an integrated U-shaped design mode of the heavy hammer structure.

### TECHNICAL FIELD

The present invention relates to a humanized heavy hammer structure.

### BACKGROUND

The traditional heavy hammer is a structure composed of two pieces of metal material, a slotted hole for accommodating a hose is formed in the middle of the traditional heavy hammer, the two-piece structure needs to be locked through a fastener (usually a bolt) alter being matched, and the installation and disassembly are difficult due to the complex underground environment of a water tank.

The other type of heavy hammer is integrated, and there is no popular reason: a. due to wrapped counterweight iron in the middle (the counterweight iron has large tolerance and high machining cost), it is difficult to position by injection molding; b. the other is that the mould is directly positioned on the configuration iron, and the produced product iron is exposed outside and rusts after long-term use; c. the swing arm of the locking buckle extends to the outside of the whole circle, and the arm of the locking buckle is easy to be hung up by debris when pulling, resulting in a poor experience.

### DISCLOSURE OF INVENTION

In order to solve the above technical problem, the object of the present invention is to provide a humanized heavy hammer structure.

The present invention discloses a following technical scheme realizes: a humanized heavy hammer structure, comprising a plastic body, a configuration metal block and a fixed block, wherein the plastic body is provided with a swing arm, an accommodating part and a U-shaped accommodating space, the configuration metal block and the fixed block are sequentially arranged in the U-shaped accommodating space, the accommodating part is arranged along the outer periphery of the plastic body, the swing arm can swing around the plastic body, and when closed, the swing arm and the accommodating part are mutually buckled; the configuration metal block is completely covered between the plastic body and the fixed block, and the configuration metal block is provided with a U-shaped notch, the fixed block is arranged in the U-shaped notch and connected with the configuration metal block, and a hose is provided in the middle of the fixed block.

Preferably, a positioning groove is provided on the inner side of the U-shaped notch, and a protruding block is protruded from the outer side of the fixed block, and the protruding block is engaged with the positioning groove to connect the fixed block and the configuration metal block.

Preferably, the outside of the protruding block is distributed with a plurality of ribs.

Preferably, the fixed block comprises a U-shaped part, and the hose is disposed through the U-shaped part.

Preferably, the accommodating parts are disposed on two sides of the gap of the U-shaped accommodating space.

Preferably, the inner side of the swing arm is provided with a buckle groove, and the accommodating part is provided with a buckle block, when the swing arm is closed, the buckle block and the buckle groove are buckled with each other.

Preferably, the swing arm comprises end portions which located at the upper and lower ends of the swing arm and disposed inwardly inclined, and a connecting block disposed between the end portions, wherein the end portions and the connecting block just fit with the gap of the U-shaped accommodating space to form a fall circle structure when the swing arm is coupled to the accommodating part.

Preferably, two extending walls are disposed on the connecting block, and a plurality of first bumps are distributed on the extending walls; the fixed block is distributed with an arc-shaped portion at the inner part of the U-shaped part, and a plurality of second bumps are distributed on the arc-shaped parts. and when the swing arm is buckled with the plastic body, the arc-shaped parts can cooperate with the extending walls to form a abdicating part for placing the hose.

Preferably, the plastic body further comprises two flat ends at the periphery, one of the flat end is disposed adjacent to the hinge area between the swing arm and the plastic body, and the other flat end is disposed adjacent to the accommodating part.

Preferably, the configuration metal block is a configuration block of iron or an alloy thereof.

The present invention discloses a humanized heavy hammer structure has following beneficial effect: firstly, the structural design of the fixed block and the counterweight metal block can effectively solve the problem that the counterweight metal of the product produced during the injection molding process is exposed outside; secondly, the whole heavy hammer structure can be more conveniently mounted and dismounted in an integrated U-shaped design mode of the heavy hammer structure; thirdly, the design mode of the swing arm structure can ensure that the swing arm is placed in the heavy hammer structure when the heavy hammer structure is closed, or the swing arm is just positioned in the full-circle structure, so that the hose can be drawn more smoothly; fourthly, through the design of the ribs on the protruding block of the fixed blocks, the problem of tolerance of metal blocks or iron blocks in the prior art can be effectively solved.

### DRAWINGS

In order to more clearly illustrate the technical solution of the present invention, the drawings required for the embodiment or the prior art description will be briefly introduced below, it is obvious that the drawings in the following description are only some embodiments of the present invention, and other drawings can be obtained by those skilled in the art without inventive efforts.

FIG. 1 is a perspective view of the present invention.

FIGS. 2 to 4 are exploded views of the present invention in different orientations.

FIG. 5 is a partial sectional view of the present invention.

FIG. 6 is a cross-sectional view of the present invention.

FIGS. 7 to 8 are perspective views of the swing arm of the present invention in an open state.

FIG. 9 is a perspective view of the heavy hammer structure with the hose installed of the present invention.

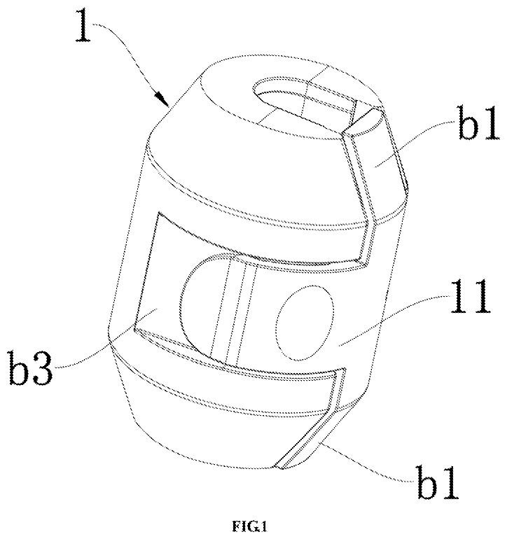

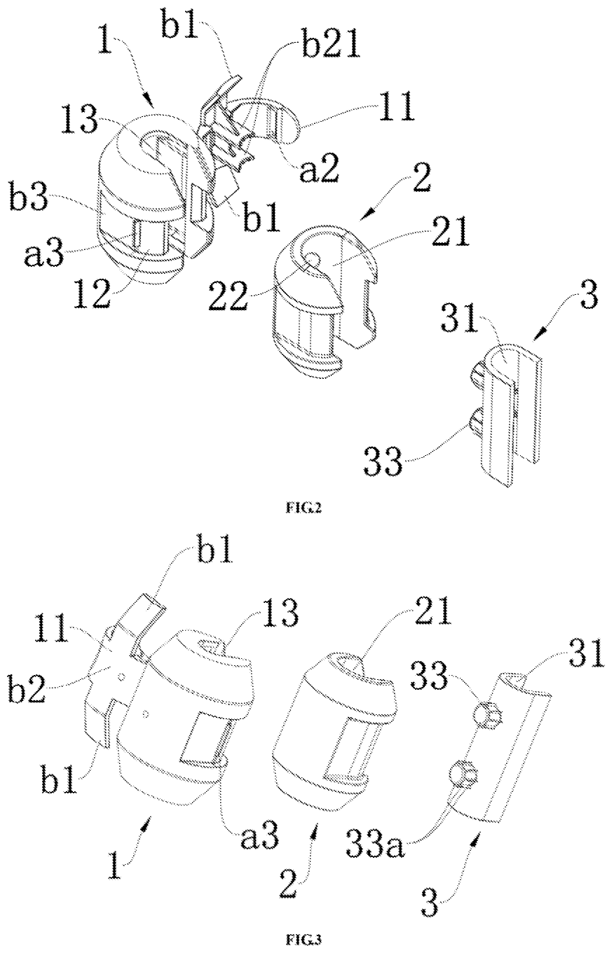

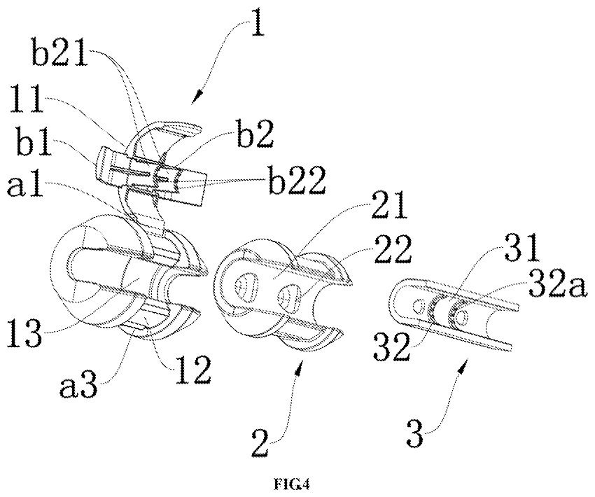

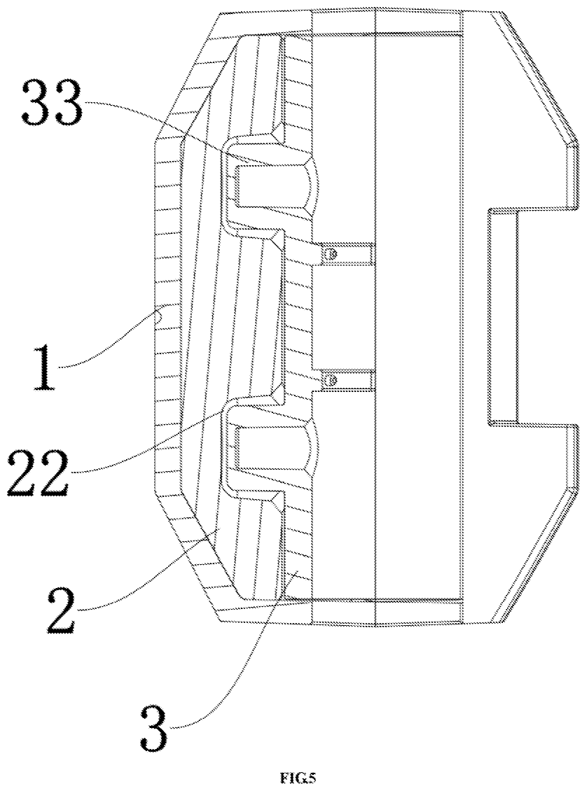

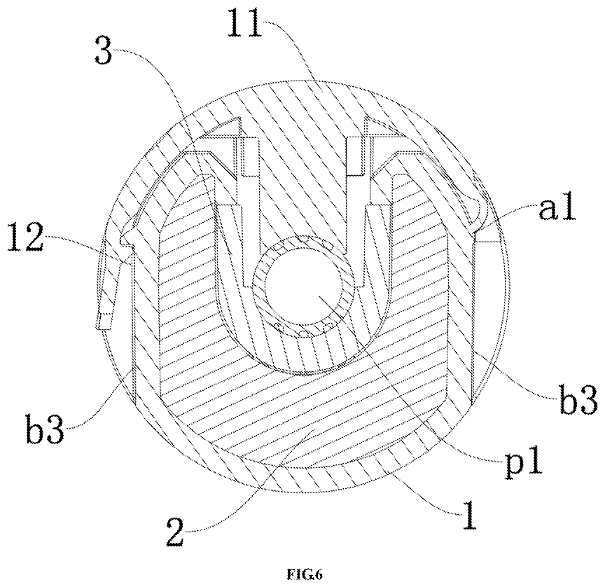

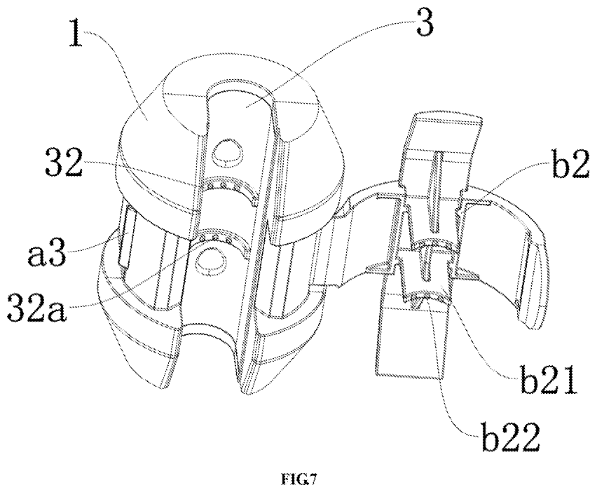

### DETAILED DESCRIPTION

The technical solutions in the embodiments of the present invention will be described clearly and completely below with reference to the accompanying drawings in the embodiments of the present invention, and it is obvious that the described embodiments are only some embodiments of the present invention, and not all embodiments. Based on the embodiments of the present invention, all other embodiments obtained by a person skilled in the art without creative efforts belong to the protection scope of the present invention.

Referring to the attached drawings 1 to 9 of the specification, a humanized heavy hammer structure comprises a plastic body 1, a configuration metal block 2 and a fixed block 3, wherein the configuration metal block 2 can be a configuration block made of iron or an alloy material thereof. The plastic body 1 is provided with a swing arm 11, an accommodating part 12 and a U-shaped accommodating space 13, the swing arm 11 can swing around the plastic body 1, the accommodating part 12 is arranged along the outer periphery of the plastic body 1, and the accommodating part 12 is distributed on two sides of the gap of the U-shaped accommodating space 13, so that the swing arm 11 and the accommodating part 12 can form a whole when being matched; specifically, the swing arm 11 and the outer side of the plastic body 1 has a hinge area a1, the swing arm 11 swings on the plastic body 1 around the hinge area a1, the swing arm 11 and the accommodating part 12 can be connected by a buckling structure, such as the inner side of the swing arm 11 is provided with a buckle groove a2, the accommodating part 12 is provided with a buckl block a3 corresponding to the position of the buckl groove a2, and when the swing arm 11 rotates to the accommodating part 12, the buckl groove a2 can be just buckled and fixed with the buckl block a3, in addition, the swing arm 11 further comprises end portions b1 which are located at the upper and lower ends of the swing arm and disposed inwardly inclined, and a connecting block b2, which is positioned between the two end portions b1, two extending walls b21 are arranged on the connecting block b2, and a plurality of first bumps b22 are distributed on the extending walls b21, and when the swing arm 11 and the accommodating part 12 are buckled, the end portions b1 at the upper and lower ends and the connecting block b2 of the swing arm 11 are just matched with the gap of the U-shaped accommodating space 13 of the plastic body 1, forming a full circle structure. Moreover, the periphery of above-mentioned plastic body 1 further provided with two flat ends b3, and one of the flat end b3 is disposed adjacent to the hinge area a1, and another flat end b3 is disposed adjacent to the accommodating part 12, and by arranging the two flat ends, on the one hand, it is beneficial for the swing arm to be stored in the full circle structure, which makes the drawing of the hose more comfortable and improves the use of experience, in addition, the design of two flat ends also can play a good effect to the subsequent mold opening process, and the whole process is more smooth.

The configuration metal block 2 is disposed in the U-shaped accommodating space 13 of the plastic body, and the middle of the metal block 2 is also provided with a U-shaped notch 21, wherein at least one positioning groove 22 is further formed at the inner side of the U-shaped notch 21, and preferably, the number of the positioning grooves 22 is two. The fixied block 3 is provided with a U-shaped part 31, two arc-shaped parts 32 are distributed on the inner side of the U-shaped part 31, and a plurality of bumps 32a are distributed on the two are-shaped parts 32, and when the swing arm is buckled with the plastic body, the two arc-shaped parts 32 can be matched with the two extending walls b21 to form a abdicating part for placing the hose, and the bumps distributed on the extending walls and the arc-shaped parts can be matched with the hose to fix the heavy hammer structure on a certain position of the hose, so that the heavy hammer structure is very convenient; in addition, the outer side of the U-shaped part 31 is convexly distributed with a protruding block 33, and the protruding block 33 can be matched with the positioning groove 22 to form a connecting structure, meanwhile, the periphery of the protruding block 33 is also distributed with a plurality of ribs 33a, the tolerance problem of the configuration metal block can be solved through the design of the ribs distributed on the periphery of the protruding block and the product reliability of the heavy hammer structure is ensured.

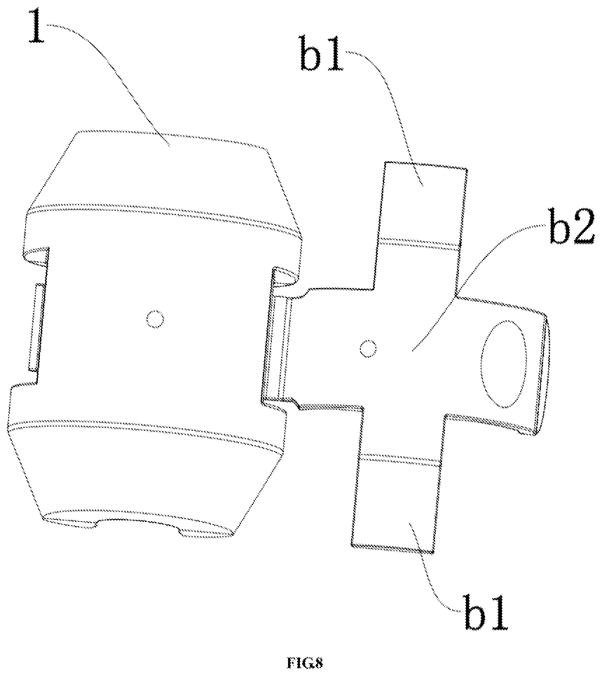

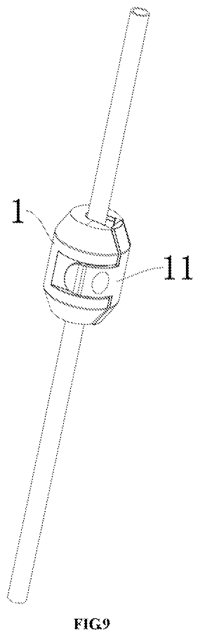

When the heavy hammer structure needs to be subjected to injection molding, the protruding block 33 of the fixed block 3 and the positioning groove 22 for arranging the configuration metal block 2 can be matched and fixed, the design of the fixed block can effectively solve the problem that the metal block generated in the injection molding process of the counterweight metal block is exposed at the periphery to rust the metal block, and the ribs distributed on the fixed block can effectively solve the problem that the tolerance for arranging the configuration metal block is large; afterwards, the above-mentioned structure is positioned on the mould, and the plastic body 1 is wrapped outside the above structure using the injection molding process and, the design of integrated U-shaped can make the installation and disassembly of the heavy hammer structure more convenient, when the hose needs to be installed, the hose installed in the U-shaped part 31, and then close the swing arm 11 and buckle the swing arm with the accommodating part to complete the installation of the hose. When the hose needs to be removed from the heavy hammer structure, it is only necessary to open the buckling structure of the swing arm 11 and the accommodating part 12 (as shown in FIGS. 7 and 8), and the heavy hammer structure can be detached from the hose, which is very fast and convenient.

While the foregoing, specification illustrates and describes the preferred embodiments of the present invention, it is to be understood that the invention is not limited to the forms disclosed herein, but is not to be construed as limited to the disclosed embodiments, and that modifications and environments may be resorted to, falling within the scope of the inventive concept as described herein, either as indicated by the above teachings or as modified by the skill or knowledge of the relevant art. But that modifications and variations may be effected by those skilled in the art without departing from the spirit and scope of the invention as defined by the appended claims.

1. A humanized heavy hammer structure, comprising a plastic body, a configuration metal block and a fixed block, wherein the plastic body is provided with a swing arm, an accommodating part and a U-shaped accommodating space, the configuration metal block and the fixed block are sequentially arranged in the U-shaped accommodating space, the accommodating part is arranged along the outer periphery of the plastic body, the swing arm can swing around the plastic body, and when closed, the swing arm and the accommodating part are mutually buckled; the configuration metal block is completely covered between the plastic body and the fixed block, and the configuration metal block is provided with a U-shaped notch, the fixed block is arranged in the U-shaped notch and connected with the configuration metal block, and a hose is provided in the middle of the fixed block.

2. The humanized heavy hammer structure as claimed in claim 1, wherein a positioning groove is provided on the inner side of the U-shaped notch, and a protruding block is protruded from the outer side of the fixed block, and the protruding block is engaged with the positioning groove to connect the fixed block and the configuration metal block.

3. The humanized heavy hammer structure as claimed in claim 2, wherein the outside of the protruding block is distributed with a plurality of ribs.

4. The humanized heavy hammer structure as claimed in claim 2, wherein the fixed block comprises a U-shaped part, and the hose is disposed through the U-shaped part.

5. The humanized heavy hammer structure as claimed in claim 1, wherein the accommodating parts are disposed on two sides of the gap of the U-shaped accommodating space.

6. The humanized heavy hammer structure as claimed in claim 1, wherein the inner side of the swing arm is provided with a buckle groove, and the accommodating part is provided with a buckle block, When the swing arm is closed, the buckle block and the buckle groove are buckled with each other.

7. The humanized heavy hammer structure as claimed in claim 5, wherein the swing arm comprises end portions which located at the upper and lower ends of the swing arm and disposed inwardly inclined, and a connecting block disposed between the end portions, wherein the end portions and the connecting block just fit with the gap of the U-shaped accommodating space to form a full circle structure when the swing arm is coupled to the accommodating part.

8. The humanized heavy hammer structure as claimed in claim 7, wherein two extending walls are disposed on the connecting block, and a plurality of first bumps are distributed on the extending walls; the fixed block is distributed with an arc-shaped portion at the inner part of the U-shaped part, and a plurality of second bumps are distributed on the ate-shaped parts, and when the swing arm is buckled with the plastic body, the arc-shaped parts can cooperate with the extending walls to form a abdicating part for placing the hose.

9. The humanized heavy hammer structure as claimed in claim 5, wherein the plastic body further comprises two flat ends at the periphery, one of the flat end is disposed adjacent to the hinge area between the swing arm and the plastic body, and the other flat end is disposed adjacent to the accommodating part.

10. The humanized heavy hammer structure as claimed in claim 1, wherein the configuration metal block is a configuration block of iron or an alloy thereof.
